(19) United States
(12) Patent Application Publication
(10) Pub. No.: US 2025/0100109 A1
(43) Pub. Date: Mar. 27, 2025

(54) Torque Tool for Welding Regulator Gages

(71) Applicant: Paul Wilson Barker, Rainbow City, AL (US)

(72) Inventor: Paul Wilson Barker, Rainbow City, AL (US)

(21) Appl. No.: 18/472,851

(22) Filed: Sep. 22, 2023

(51) Int. Cl. B25B 13/48; B25B 23/00

(52) U.S. Cl. CPC B25B 13/48; B25B 23/00

(57) ABSTRACT

A torque tool for welding regulator gages includes a wrench body, a retention pin, and a tab. The wrench body is configured with a handle and a wrench-head. The handle is externally and laterally connected to the wrench-head as torque is applied through the handle. The wrench-head is engaged with the inlet fitting of the welding regulator gage so that the gage can be removed from or attached to the gas cylinder. The tab is perpendicularly positioned to the handle and externally connected to the wrench-head. The retention pin is slidably engaged within the tab as the retention pin accurately gages insertion depth of the wrench-head around the inlet fitting of the gage and retains the wrench-head around the inlet fitting of the gage.

### FIELD OF THE INVENTION

The present invention relates generally to a torque tool. More specifically, the present invention is a torque tool for welding regulator gages so that a gas cylinder can be quickly attached to or detached from the inlet fitting of the welding regulator gage.

### BACKGROUND OF THE INVENTION

A welding regulator gage is generally attached to a gas cylinder so that the welding tool can be operated via the stored gas (Oxygen, Argon, or Acetylene) of the gas cylinder. More specifically, the inlet fitting of the gage is attached to the gas cylinder so that the stored gas can be discharged into the gage. Then, the gage is able to regulate and discharge the gas into the attachment hose of the welding tool. However, the exchanging of the gas cylinder has become a time-consuming process since the users have to search for the correct wrench that mounts/removes the gas cylinder from the gage. Oftentimes, the gages get damaged due to the usage of the incorrect wrench.

It is therefore an objective of the present invention to provide a torque too for the welding regulator gage that remains about the inlet fitting of the gage. The present invention is an inexpensive torque tool specially designed for the inlet fitting of the gage. As a result, when the gas cylinder has to be replaced, the user can simply utilize the present invention that is positioned adjacent to the inlet fitting of the gage thus saving time during the gas cylinder exchange. The present invention is also integrated with a retention pin to accurately gage the insertion depth of the present invention around the inlet fitting of the gage.

### BRIEF DESCRIPTION OF THE DRAWINGS

FIG. 1 is a perspective view of the present invention.

FIG. 2 is another perspective view of the present invention.

FIG. 3 is a side view of the present invention.

FIG. 4 is another side view of the present invention.

FIG. 5 is a perspective view of the present invention showing the pin-receiving opening.

FIG. 6 is a detailed view of the wrench-head of the present invention.

FIG. 7 is a side view of the retention pin of the present invention.

FIG. 8 is an exploded view of the present invention, wherein the retention pin is separated from the tab.

FIG. 9 is a side view of the present invention, showing the attachment between the retention pin and one of the plurality of engagement features.

### DETAILED DESCRIPTION OF THE INVENTION

All illustrations of the drawings are for the purpose of describing selected versions of the present invention and are not intended to limit the scope of the present invention.

The present invention is a torque tool for welding regulator gages so that the users can easily and quickly change the gas cylinder. More specifically, the present invention remains with the welding regulator gages and positioned adjacent to an inlet fitting of the welding regulator gages. As a result, when an empty gas cylinder has to be removed, the user can easily slide in the present invention along the inlet fitting to loosen an attachment nut of the inlet fitting. Then, the present invention can be utilized again to tighten the attachment nut of the inlet fitting to hermetically mount the new gas cylinder.

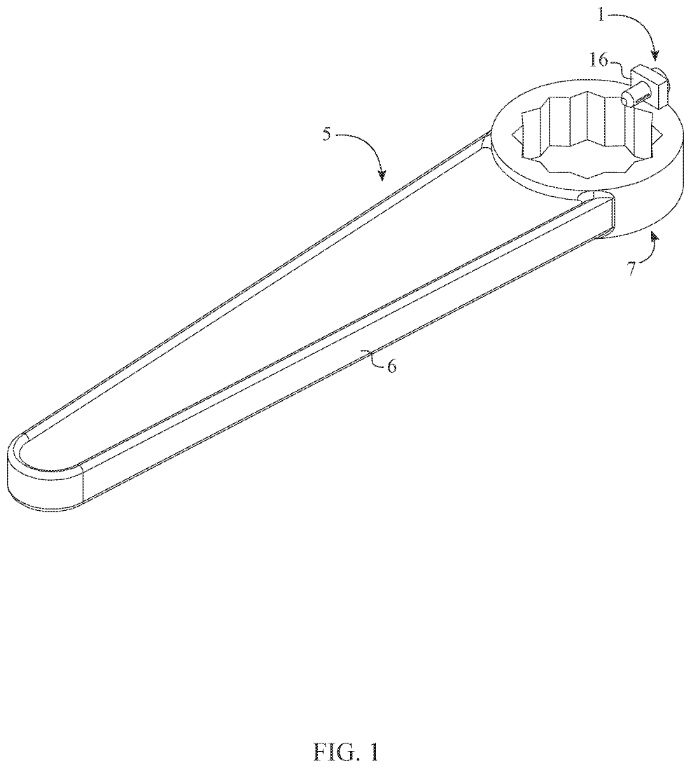

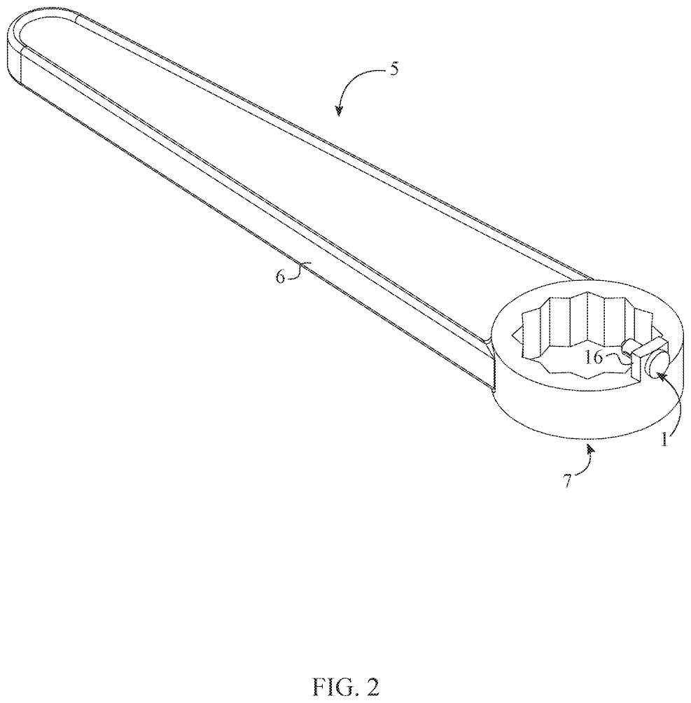

As shown in FIG. 1 and FIG. 2, the present invention comprises a wrench body 5, a retention pin 1, and a tab 16. In reference to a general configuration of the present invention, the wrench body 5 applies the necessary torque to loosen or tighten the attachment nut and comprises a handle 6 and a wrench-head 7. The handle 6 is externally and laterally connected to the wrench-head 7. Resultantly, when the user applies torque to the handle 6, the handle 6 is able to transfer the applied torque to the wrench-head 7 as the wrench-head 7 is engaged with the attachment nut. The tab 16 is perpendicularly positioned to the handle 6 and externally connected to the wrench-head 7. In other words, the tab 16 is outwardly extended from one of the side surface of the wrench-head 7. The retention pin 1 is slidably engaged within the tab 16 so that the retention pin 1 is able to accurately gage the insertion depth of the wrench-head 7 around the attachment nut and prevent separation of the wrench-head 7 from the welding regulator gage.

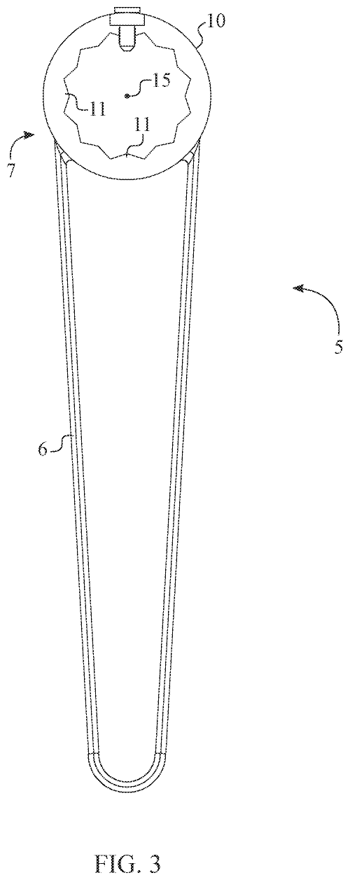

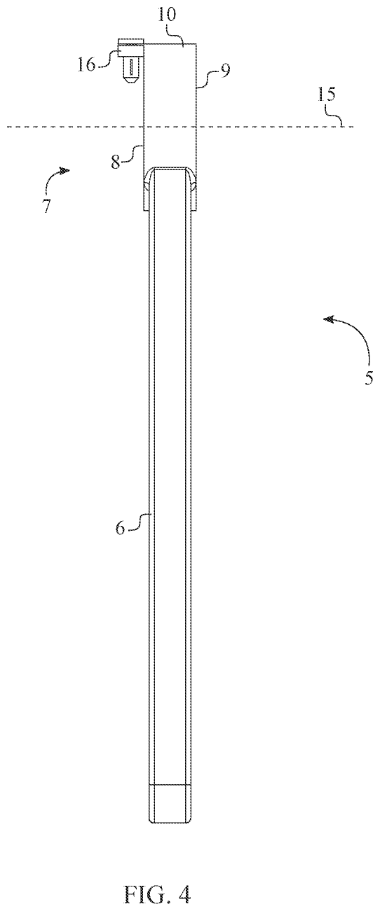

In reference to FIG. 3 and FIG. 4, the handle 6 is an elongated arm that allows the user to comfortably applies torque. The wrench-head 7 is shaped similar to a box end wrench design. Due to the box end wrench design, when the present invention is placed about the inlet fitting, the present invention does not fall out of the inlet fitting or cannot be removed from the inlet fitting as the wrench-head 7 is loosely positioned between the attachment nut and a regulator of the welding regulator gage. As shown in FIG. 3 and FIG. 4, the wrench body 5 may further comprise a plurality of engagement features 11 and a rotational axis 15. The rotational axis 15 concentrically traverses through the wrench-head 7. The plurality of engagement features 11 is radially distributed around the rotational axis 15 thus allowing the plurality of engagement features 11 to firmly grip the attachment nut. Preferably, the plurality of engagement features 11 is configured to accommodate 1⅛ inches (1.125 inches). However, the plurality of engagement features 11 can be configured to tightly engage with any industry standard attachment nut and not limited to the 1.125 inches. Furthermore, the wrench-head 7 is outwardly extended from the plurality of engagement features 11 to an outer wall 10 of the wrench-head 7 thus allowing the attachment nut to be concentrically engaged within the wrench-head 7. In order to fully grip the attachment nut, the plurality of engagement features 11 is extended from a first base wall 8 of the wrench-head 7 to a second base wall 9 of the wrench-head 7.

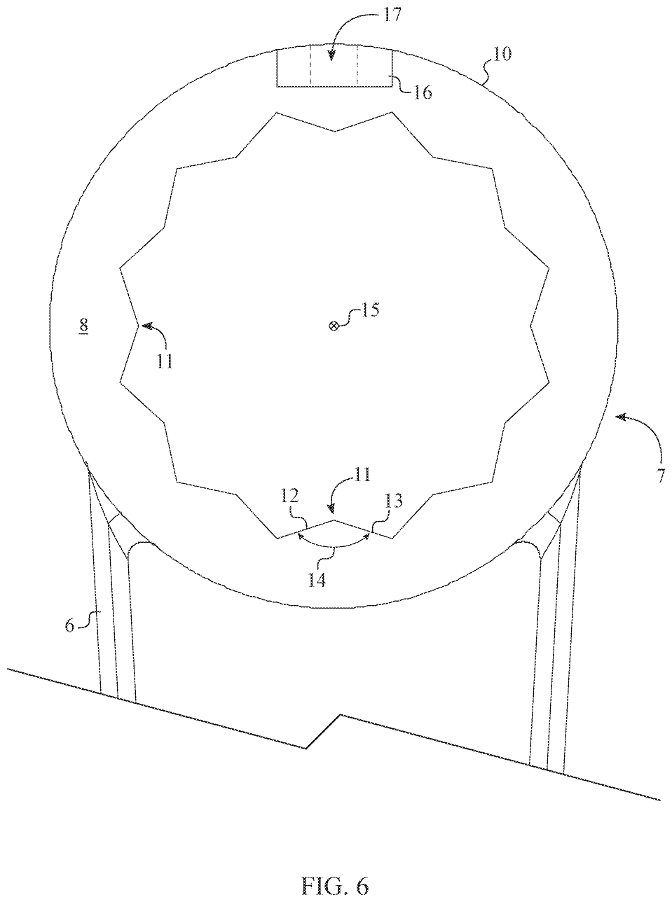

In reference to FIG. 6, each of the plurality of engagement features 11 may comprise a first bracing surface 12, a second bracing surface 13, and an obtuse angle 14. More specifically, the first bracing surface 12 and the second bracing surface 13 are angularly connected to each other at the obtuse angle 14. Furthermore, a length of the first bracing surface 12 is equal to a length of the second bracing surface 13 as the connection point between the first bracing surface 12 and the second bracing surface 13 oriented towards the rotational axis 15. Preferably, the plurality of engagement features 11 is twelve engagement features so that the present invention is able to benefit from having more positions for engaging the attachment nut to overcome limited space between the attachment nut and the regulator. However, the plurality of engagement features 11 can be any number engagement features other than the twelve engagement features without deviating from the scope of the functionality.

In reference to FIG. 4, the handle 6 is symmetrically positioned in between the first base wall 8 of the wrench-head 7 and the second base wall 9 of the wrench-head 7 to minimize the stress between the handle 6 and the wrench-head 7. As a result, the handle 6 is laterally connected to the outer wall 10 of the wrench-head 7 and outwardly extended parallel to the first base wall 8 and the second base wall 9. Furthermore, the handle 6 is configured with a rounded outer edge to minimize the stress on the users hand.

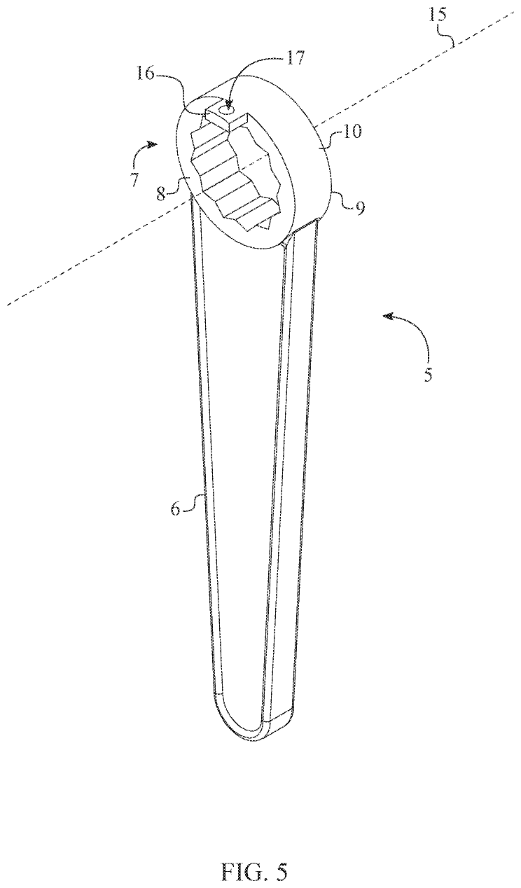

The tab 16 that allows the retention pin 1 to be slidably engaged is configured into a cubical shape as the tab 16 is adjacently connected to the first base wall 8 of the wrench-head 7 and perpendicularly positioned to the first base wall 8. Furthermore, the tab 16 is positioned flushed with the outer wall 10 of the wrench-head 7 and positioned offset from the plurality of engagement features 11. The present invention may further comprise a pin-receiving opening 17 as shown in FIG. 5, wherein the pin-receiving opening 17 facilitate the movement of the retention pin 1. More specifically, the pin-receiving opening 17 concentrically traverses through the tab 16 thus allowing the pin-receiving opening 17 to be linearly oriented from the outer wall 10 of the wrench-head 7 to the rotational axis 15 of the wrench body 5. Resultantly, the retention pin 1 is able slidably engage within the pin-receiving opening 17 to prevent separation of the wrench-head 7 from the welding regulator gage as the retention pin 1 stops the wrench-head 7 about the attachment nut.

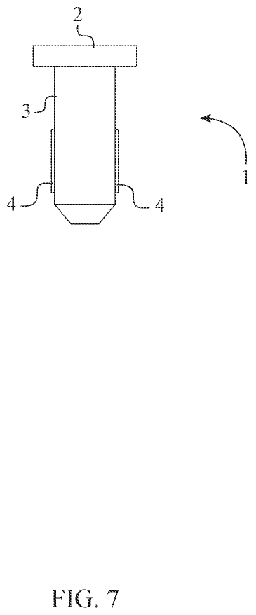

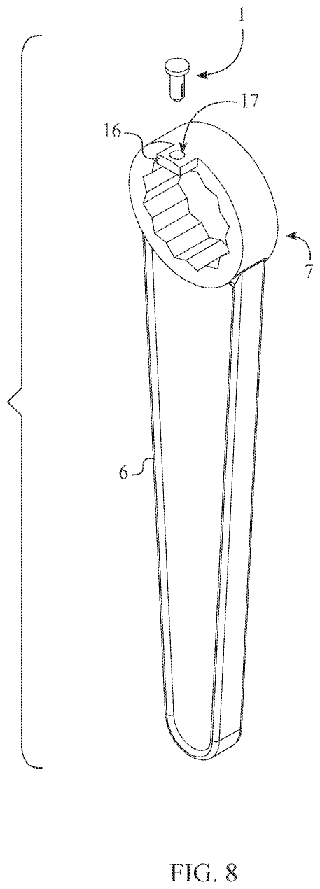

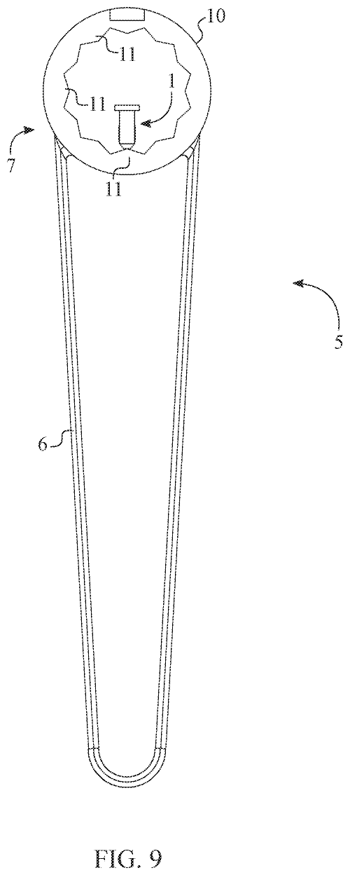

To ensure that the retention pin 1 does not get lost during packing and shipping process, the retention pin 1 is temporally attached to one of the plurality of engagement features 11 and positioned within the plurality of engagement features 11 as shown in FIG. 9. Once the present invention is ready to be installed within the welding regulator gage, the user has to first remove (snap-off) the retention pin 1 from the corresponding engagement feature. Then, the wrench-head 7 is inserted to the inlet fitting through the attachment nut thus confirming that the tab 16 is oriented towards the regulator. The user can then insert the retention pin 1 into the pin-receiving opening 17, wherein the retention pin 1 stops the separation of the wrench-head 7 from the inlet fitting. In reference to FIG. 7 and FIG. 8, the retention pin 1 may comprise a pin-head 2, a shaft 3, and a plurality of locking tracks 4. The pin-head 2 and the shaft 3 are concentrically positioned of each other in such a way that the pin-head 2 is adjacently connected to the shaft 3. For example, when the retention pin 1 is engaged within the tab 16, the pin-head 2 is positioned adjacent to the outer wall 10 of the wrench-head 7 as the shaft 3 is positioned adjacent to the plurality of engagement features 11. Each of the plurality of locking tracks 4 is radially connected along the shaft 3 so that the plurality of locking tracks 4 can prevent unintentional separation of the retention pin 1 from the tab 16. In other words, the plurality of locking tracks 4 keeps the shaft 3 of the retention pin 1 within the pin-receiving opening 17 unless the retention pin 1 is forced out or pulled from the pin-receiving opening 17.

In order to reduce the cost of manufacturing and the overall weight, the present invention is made from high strength and light-weight material such as aluminum, composite, or plastic. Preferably, the present invention is made from Polyamide 6 PA6 GF15 (15% glass fiber reinforced, heat stabilized polyamide).

Even though the preferred embodiment is explained in relation to the welding regulator gages, the present invention can be utilized with any other type of gas regulator gages that are used within hospitals, medical facilities, dentist offices, supply shops, fabrication shops, or any other types of facilities that uses gas cylinders such as Oxygen, Nitrogen, Argon, or Acetylene.

Although the invention has been explained in relation to its preferred embodiment, it is to be understood that many other possible modifications and variations can be made without departing from the spirit and scope of the invention as hereinafter claimed.

What is claimed is:

1. A torque tool for welding regulator gages comprising:
a wrench body;
a retention pin;
a tab;
the wrench body comprising a handle and a wrench-head;
the handle being externally and laterally connected to the wrench-head;
the tab being perpendicularly positioned to the handle;
the tab being externally connected to the wrench-head; and
the retention pin being slidably engaged within the tab.

2. The torque tool for welding regulator gages as claimed in claim 1 comprising:
the wrench body further comprising a plurality of engagement features and a rotational axis;
the rotational axis concentrically traversing through the wrench-head;
the plurality of engagement features being radially distributed around the rotational axis;
the wrench-head being outwardly extended from the plurality of engagement features to an outer wall of the wrench-head; and
the plurality of engagement features being extended from a first base wall of the wrench-head to a second base wall of the wrench-head.

3. The torque tool for welding regulator gages as claimed in claim 1 comprising:
each of the plurality of engagement features comprising a first bracing surface, a second bracing surface, and an obtuse angle; and
the first bracing surface and the second bracing surface being angularly connected to each other at the obtuse angle.

4. The torque tool for welding regulator gages as claimed in claim 3, wherein a length of the first bracing surface is equal to a length of the second bracing surface.

5. The torque tool for welding regulator gages as claimed in claim 3, wherein the plurality of engagement features is twelve engagement features.

6. The torque tool for welding regulator gages as claimed in claim 1 comprising:
the handle being symmetrically positioned in between a first base wall of the wrench-head and a second base wall of the wrench-head; and
the handle being laterally connected to an outer wall of the wrench-head.

7. The torque tool for welding regulator gages as claimed in claim 1 comprising:
a pin-receiving opening;
the tab being adjacently connected to a first base wall of the wrench-head;
the tab being perpendicularly positioned to the first base wall;
the pin-receiving opening concentrically traversing through the tab;
the pin-receiving opening being linearly oriented from an outer wall of the wrench-head to a rotational axis of the wrench body; and
the retention pin being slidably engaged within the pin-receiving opening.

8. The torque tool for welding regulator gages as claimed in claim 1 comprising:
the retention pin comprising a pin-head, a shaft, and a plurality of locking tracks;
the pin-head and the shaft being concentrically positioned of each other;
the pin-head being adjacently connected the shaft; and
each of the plurality of locking tracks being radially connected along the shaft.

9. A torque tool for welding regulator gages comprising:
a wrench body;
a retention pin;
a tab;
the wrench body comprising a handle, a wrench-head, a plurality of engagement features, and a rotational axis;
the handle being externally and laterally connected to the wrench-head;
the rotational axis concentrically traversing through the wrench-head;
the plurality of engagement features being radially distributed around the rotational axis;
the wrench-head being outwardly extended from the plurality of engagement features to an outer wall of the wrench-head;
the plurality of engagement features being extended from a first base wall of the wrench-head to a second base wall of the wrench-head;
the tab being perpendicularly positioned to the handle;
the tab being externally connected to the wrench-head; and
the retention pin being slidably engaged within the tab.

10. The torque tool for welding regulator gages as claimed in claim 9 comprising:
each of the plurality of engagement features comprising a first bracing surface, a second bracing surface, and an obtuse angle; and
the first bracing surface and the second bracing surface being angularly connected to each other at the obtuse angle.

11. The torque tool for welding regulator gages as claimed in claim 9, wherein a length of the first bracing surface is equal to a length of the second bracing surface.

12. The torque tool for welding regulator gages as claimed in claim 9, wherein the plurality of engagement features is twelve engagement features.

13. The torque tool for welding regulator as claimed in claim 9 comprising:
the handle being symmetrically positioned in between the first base wall of the wrench-head and the second base wall of the wrench-head; and
the handle being laterally connected to the outer wall of the wrench-head.

14. The torque tool for welding regulator gages as claimed in claim 9 comprising:
a pin-receiving opening;
the tab being adjacently connected to the first base wall of the wrench-head;
the tab being perpendicularly positioned to the first base wall;
the pin-receiving opening concentrically traversing through the tab;
the pin-receiving opening being linearly oriented from the outer wall of the wrench-head to a rotational axis of the wrench body; and
the retention pin being slidably engaged within the pin-receiving opening.

15. The torque tool for welding regulator gages as claimed in claim 9 comprising:
the retention pin comprising a pin-head, a shaft, and a plurality of locking tracks;
the pin-head and the shaft being concentrically positioned of each other;
the pin-head being adjacently connected the shaft; and
each of the plurality of locking tracks being radially connected along the shaft.

16. A torque tool for welding regulator gages comprising:
a wrench body;
a retention pin;
a tab;
the wrench body comprising a handle, a wrench-head, a plurality of engagement features, and a rotational axis;
the handle being externally and laterally connected to the wrench-head;
the rotational axis concentrically traversing through the wrench-head;
the plurality of engagement features being radially distributed around the rotational axis;
the wrench-head being outwardly extended from the plurality of engagement features to an outer wall of the wrench-head;
the plurality of engagement features being extended from a first base wall of the wrench-head to a second base wall of the wrench-head;
the handle being symmetrically positioned in between the first base wall of the wrench-head and the second base wall of the wrench-head;
the handle being laterally connected to the outer wall of the wrench-head;
the tab being perpendicularly positioned to the handle;
the tab being externally connected to the wrench-head; and
the retention pin being slidably engaged within the tab.

17. The torque tool for welding regulator gages as claimed in claim 16 comprising:
each of the plurality of engagement features comprising a first bracing surface, a second bracing surface, and an obtuse angle;
the first bracing surface and the second bracing surface being angularly connected to each other at the obtuse angle; and
a length of the first bracing surface being equal to a length of the second bracing surface.

18. The torque tool for welding regulator gages as claimed in claim 16, wherein the plurality of engagement features is twelve engagement features.

19. The torque tool for welding regulator gages as claimed in claim 16 comprising:
a pin-receiving opening;
the tab being adjacently connected to the first base wall of the wrench-head;
the tab being perpendicularly positioned to the first base wall;
the pin-receiving opening concentrically traversing through the tab;
the pin-receiving opening being linearly oriented from the outer wall of the wrench-head to a rotational axis of the wrench body; and
the retention pin being slidably engaged within the pin-receiving opening.

20. The torque tool for welding regulator gages as claimed in claim 16 comprising:
the retention pin comprising a pin-head, a shaft, and a plurality of locking tracks;
the pin-head and the shaft being concentrically positioned of each other;
the pin-head being adjacently connected the shaft; and
each of the plurality of locking tracks being radially connected along the shaft.
